(19) United States
(12) Patent Application Publication
(10) Pub. No.: US 2017/0203600 A1
(43) Pub. Date: Jul. 20, 2017

(54) Bookmark Belt Structure

(71) Applicant: WEI-YING CHIEN, Nantou County (TW)

(72) Inventor: WEI-YING CHIEN, Nantou County (TW)

(21) Appl. No.: 15/406,778

(22) Filed: Jan. 15, 2017

(30) Foreign Application Priority Data
Jan. 15, 2016 (TW) 105200548

(51) Int. Cl. B42D 9/00

(52) U.S. Cl. CPC B42D 9/005

(57) ABSTRACT

A bookmark belt structure includes a bookmark belt, a clip member, a hanging member, and a decoration member. The bookmark belt is in the form of an elongated strip. The clip member includes a plate. One end of the plate has a turning portion extending in an opposite direction to form a clip piece. A slit is formed between the clip piece and the plate. One end of the bookmark belt is bound to the clip member. One end of the hanging member is connected to the other end of the bookmark belt. The decoration member is attached to the clip member. Through the aforesaid structure, the clip member may be used to clip the cover page or the inside page of a book so that one end of the bookmark belt is connected with the book to prevent the bookmark belt from being lost or slipping off.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

The present invention relates to a bookmark belt structure, and more particularly to a bookmark belt for connecting a book to achieve the functions of book classification and easy finding.

Description of Related Arts

For reading a book, most people may use a bookmark to be inserted between the inside pages of the book if he/she wants to pause the reading so as to mark the page read. Next time, the book is opened to the page where the bookmark is placed, so that the reader can quickly find the previous reading paragraph. A conventional bookmark is in the form of a ribbon marker extending from the tailband of a book, which is an extension structure of the book itself. When in use, the ribbon marker is pulled to be inserted between the inside pages of the book, and the free end of the ribbon marker is exposed out of the book as the guide of next reading. However, the production of the tailband and the ribbon marker is labor-consuming and time-consuming. In addition, many publications do not allow the insertion of the tailband and the ribbon marker, so most publications rely on an external bookmark as a media for the purposes of separation, paging and indexing. In general, a bookmark is in the form of a sheet. The upper end of the bookmark has a small hole. A ribbon is tied to the small hole. When in use, the bookmark is inserted between the inside pages of a book, and the ribbon is exposed above the book for next reading. However, the bookmark itself is not directly connected to the book, so it has the following shortcomings when in use.
1. The bookmark is a single sheet, and it itself cannot be secured to the inside page of a book. When the book is closed, the bookmark is sandwiched in the book. When the book is opened or carried with the user, the bookmark tends to slip off. Besides, the ribbon of the bookmark may displace into the inside pages of the book. The user needs to rummage the pages of the book.
2. When the bookmark in the form of a sheet is not used, it is not easy to store the bookmark, so the bookmark may be lost.

Accordingly, the inventor of the present invention has devoted himself based on his many years of practical experiences to solve these problems.

### SUMMARY OF THE PRESENT INVENTION

The primary object of the present invention is to solve the aforesaid problems and to provide a bookmark belt structure. One end of a bookmark belt is provided with a clip member, and another end the bookmark belt is provided with a hanging member. When in use, the clip member is exposed outside a book and used to clip the cover page or the inside page of the book so that one end of the bookmark belt is connected with the book to prevent the bookmark belt from being lost or slipping off. The hanging member makes the other end of the bookmark belt have a downward gravity, such that the bookmark belt can be sandwiched in between the inside pages of the book.

### BRIEF DESCRIPTION OF THE DRAWINGS

FIG. 1 is an exploded view of the present invention;

FIG. 2 is a perspective view of the present invention;

FIG. 3 is a perspective view of the present invention used to clip the cover page of a book;

FIG. 4 is a perspective view of the present invention used to clip the inside pages of a book;

FIG. 5 is a perspective view of the present invention used to classify books;

FIG. 6 is an exploded view of another embodiment of the present invention;

FIG. 7 is a perspective view of another embodiment of the clip member of the present invention; and

FIG. 8 is a perspective view of a further embodiment of the clip member of the present invention.

### DETAILED DESCRIPTION OF THE PREFERRED EMBODIMENT

Embodiments of the present invention will now be described, by way of example only, with reference to the accompanying drawings.

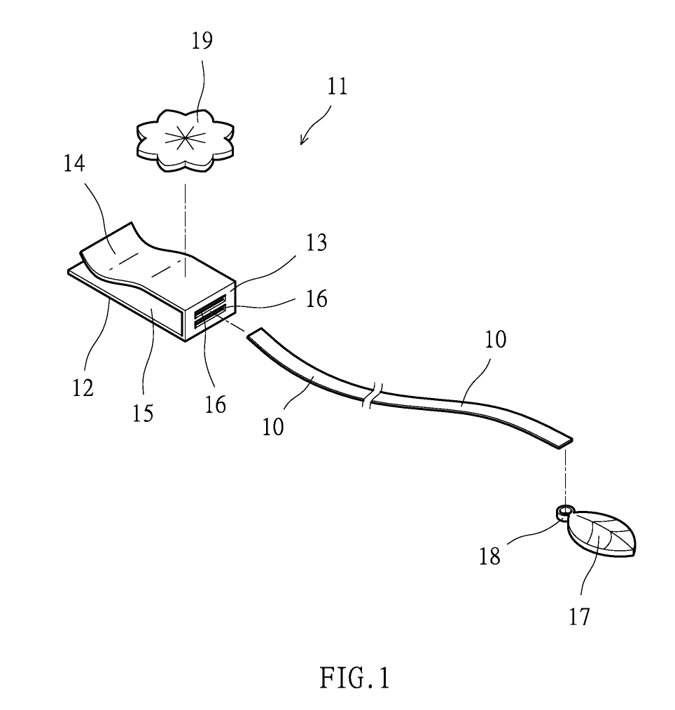

As shown in FIG. 1 to FIG. 5, a bookmark belt structure according to a preferred embodiment of the present invention comprises a bookmark belt 10, a clip member 11, a hanging member 17, and a decoration member 19. The bookmark belt 10 is in the form of an elongated strip. The clip member 11 includes a plate 12. One end of the plate 12 has a turning portion 13 extending in an opposite direction to form a clip piece 14. A slit 15 is formed between the clip piece 14 and the plate 12. The turning portion 13 is formed with a binding hole 16. One end of the bookmark belt 10 is bound to the binding hole 16. The hanging member 17 is in the form of a sheet having a predetermined shape. One end of the hanging member 17 is formed with a perforation 18. Another end of the bookmark belt 10 is bound to the perforation 18. The decoration member 19 is in the form of a sheet having a predetermined shape. The decoration member 19 may be attached to the plate 12 or the clip piece 14 of the clip member 11, so that the decoration member 19 can selectively decorate the clip member 11. Through the aforesaid structure, the clip member 11 may be used to clip the cover page or the inside page of a book so that one end of the bookmark belt 10 is connected with the book to prevent the bookmark belt 10 from being lost or slipping off. The clip member 11 or the decoration member 19 can achieve the practical functions of striking book classification and easy finding.

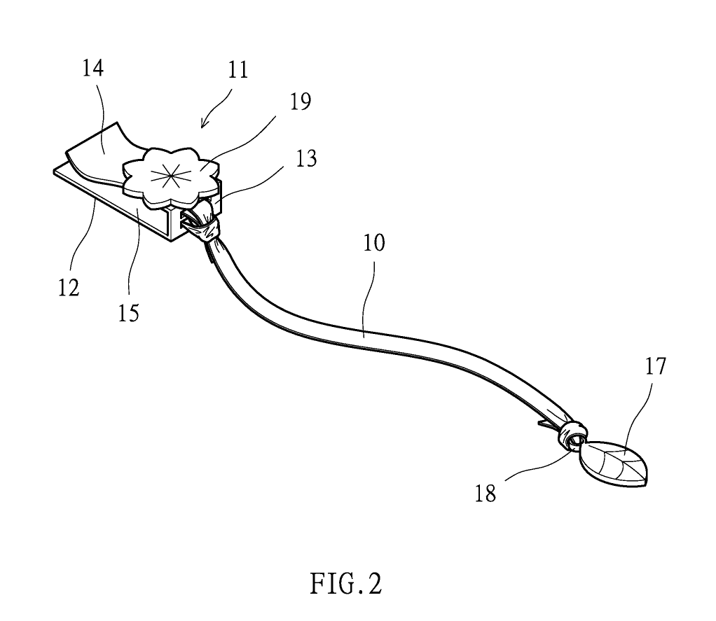

The assembly, operation and details of the above embodiment are described below. Referring to FIGS. 1 to 2, the bookmark belt 10 of this embodiment is a ribbon made of leather or cloth. The hanging member 17 and the decoration member 19 are made of metal, paper, cloth, wood, plastic, rubber or glass. The hanging member 17 and the decoration member 19 can be shaped as one of a geometric pattern, a plant, an animal, an anime pattern, a character or a combination thereof, so that it has a diversified form. The clip member 11 may be in the form of a resilient sheet to increase its clip capacity, and it may be formed with an immovable slit 15 to function as a book anchor capable of interposing the cover page of the inside page of a book. The hanging member 17 provides a different styling appearance, and more importantly, by virtue of its weight, the bookmark belt 10 can be securely sandwiched in between the inside pages of a book for easy clipping.

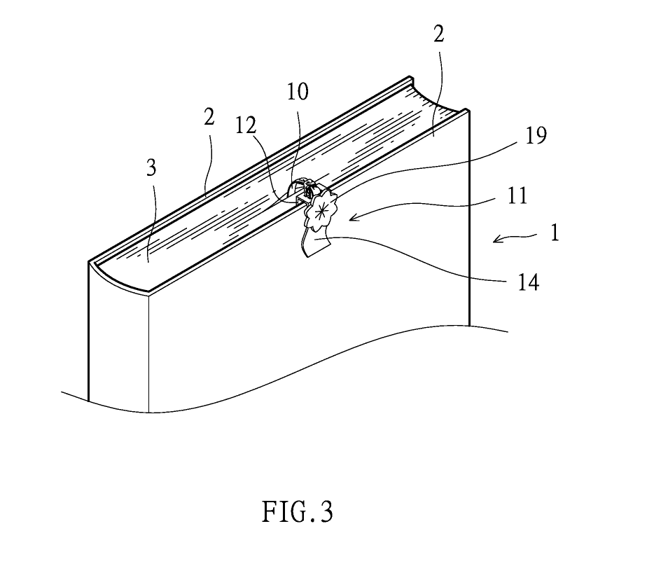

FIG. 3 is a schematic view of the present invention when in use. When the reader stops reading, the clip member 11 is placed on the cover page 2 of the book 1, the plate 12 is attached to the inner side of the cover page 2, and the clip piece 14 is attached to the outer side of the cover page 2, such that the clip member 11 is exposed outside the book 1 and the bookmark belt 10 is sandwiched in between the inside pages of the book 1 to achieve a guide function for the user to read the book 1 next time.

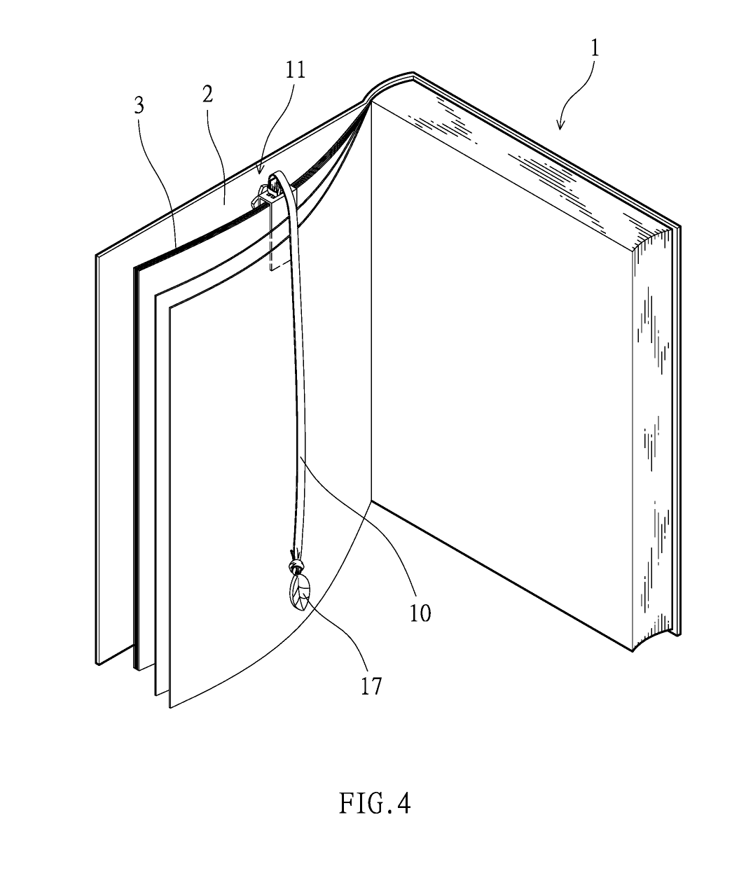

FIG. 4 illustrates another use of the present invention. When the reader stops reading, the clip member 11 is placed on the inside pages 3 of the book 1 and the bookmark belt 10 is sandwiched in between the inside pages 3 of the book 1, such that the clip member 11 is exposed outside the book 1 to achieve a guide function for the user to read the book 1 next time.

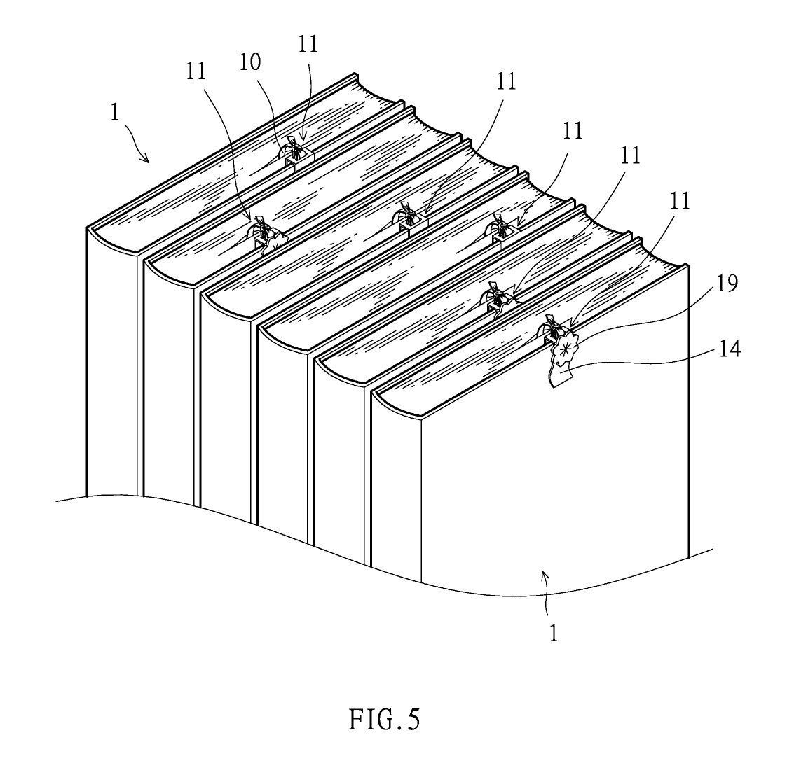

Referring to FIG. 5, the outer surface of the clip member 11 is designed with a pattern for identifying and classifying books, or the decoration member 19 is designed in a striking and prominent manner. The decoration member 19 may be marked or printed with a character to facilitate the placement of books so that the reader can easily and clearly find the location of a book to provide an effective guide.

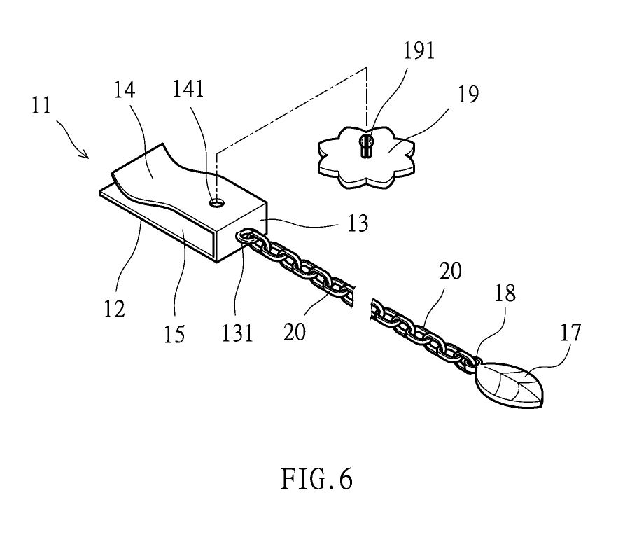

FIG. 6 is another embodiment of the present invention. The bookmark belt 20 is in the form of a chain. The turning portion 13 of the clip member 11 is provided with a retaining ring 131. One end of the bookmark belt 20 is buckled and connected to the retaining ring 131 of the clip member 11, and the other end of the bookmark belt 20 is connected to the perforation 18 of the hanging member 17. In this embodiment, the clip piece 14 of the clip member 11 is formed with an engaging hole 141. The back of the decoration member 19 is provided with an engaging post 191 corresponding to the engaging hole 141. The engaging post 191 is engaged with the engaging hole 141, so that the decoration member 19 is fixed to the clip member 11. The decoration member 19 can be installed and replaced conveniently.

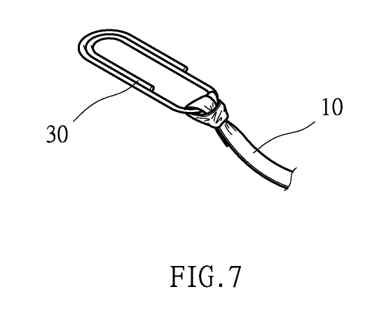

FIG. 7 illustrates another embodiment of the clip member of the present invention. The clip member 30 may be in the form of a paper clip. One end of the bookmark belt 10 is bound to one end of the clip member 30. The clip member 30 may be used to clip the cover page of a book so that the bookmark belt 10 is connected with the book to prevent the bookmark belt 10 from being lost or slipping off.

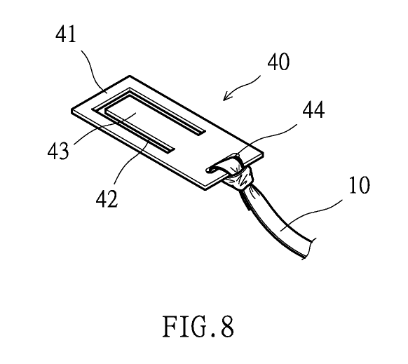

FIG. 8 illustrates a further embodiment of the clip member of the present invention. The clip member 40 is in the form of a plate body 41 having a through hole 44 at one end thereof. The plate body 41 is provided with a U-shaped slot 42 near the periphery thereof to form an elastic piece 43. The bookmark belt 10 is bound to the through hole 44. When in use, the elastic piece 43 can be pulled at an angle and the pages of the book can be sandwiched between the plate body 41 and the elastic sheet 43, so that the bookmark belt 10 is connected to the book to prevent the bookmark belt 10 from being lost and slipping off.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A bookmark belt structure, comprising a bookmark belt, a clip member, and a hanging member; the bookmark belt being in the form of an elongated strip; the clip member being connected with one end of the bookmark belt; the hanging member being in the form of a sheet having a predetermined shape and connected with another end of the bookmark belt.

2. The bookmark belt structure as claimed in claim 1, wherein the clip member includes a plate, one end of the plate has a turning portion extending in an opposite direction to form a clip piece, a slit is formed between the clip piece and the plate, the turning portion is provided with a binding hole or a retaining ring for connection of one end of the bookmark belt, and one end of the hanging member is formed with a perforation for connection of the other end of the bookmark belt.

3. The bookmark belt structure as claimed in claim 1, wherein the clip member is in the form of a plate body having a through hole at one end thereof, the plate body is provided with a U-shaped slot near a periphery thereof to form an elastic piece, and the bookmark belt is bound to the through hole.

4. The bookmark belt structure as claimed in claim 1, wherein the clip member is provided with a decoration member thereon, the clip piece of the clip member is formed with an engaging hole, a back of the decoration member is provided with an engaging post corresponding to the engaging hole, and the engaging post is engaged with the engaging hole so that the decoration member is fixed to the clip member.
